(19) United States
(12) Patent Application Publication
(10) Pub. No.: US 2024/0208342 A1
(43) Pub. Date: Jun. 27, 2024

(54) PLUG CONNECTOR PART FOR A CHARGING SYSTEM FOR CHARGING AN ELECTRIC VEHICLE

(71) Applicant: Phoenix Contact E-Mobility GmbH, Schieder-Schwalenberg (DE)

(72) Inventors: Simon STAMM, Paderborn (DE); Edmund NEUMANN, Hameln (DE); Carsten KUCKUCK, Hameln (DE)

(21) Appl. No.: 18/544,547

(22) Filed: Dec. 19, 2023

(30) Foreign Application Priority Data
Dec. 21, 2022 (BE) 2022/6055

(51) Int. Cl. B60L 53/16; H01R 13/52; H01R 13/66

(52) U.S. Cl. CPC B60L 53/16; H01R 13/5208; H01R 13/6683

(57) ABSTRACT

A plug connector part of a charging system for charging an electric vehicle, the plug connector part being connectable to a mating plug connector part along a plug-in direction, the plug connector part including: a housing part; a support element connected to the housing part; at least one electrical plug contact arranged on the support element for plugging connection to a mating contact of the mating plug connector part; and a temperature sensor assembly arranged on the support element and having a temperature sensor element in operative connection with the at least one electrical plug contact for measuring a temperature at the at least one electrical plug contact. The temperature sensor element has a first engagement section in positive engagement with a second engagement section of the at least one electrical plug contact so that the at least one electrical plug contact is fixed axially along the plug-in direction.

### CROSS-REFERENCE TO PRIOR APPLICATION

Priority is claimed to Belgian Patent Application No. BE 2022/6055, filed on Dec. 21, 2022, the entire disclosure of which is hereby incorporated by reference herein.

### FIELD

The invention relates to a plug connector part of a charging system for charging an electric vehicle, and to a charging system for charging an electric vehicle.

### BACKGROUND

Such a plug connector part can be connected by being plugged into a mating plug connector part along a plug-in direction, and comprises a housing part, a support element connected to the housing part, and at least one electrical plug contact arranged on the support element for plugging connection to a mating contact of the mating plug connector part. A temperature sensor assembly is arranged on the support element and has a temperature sensor element in operative connection with the at least one electrical plug contact for measuring a temperature at the at least one electrical plug contact.

Such a plug connector part can be designed as a plug connector part on the charging cable, also referred to as a charging plug, or a plug connector part on the vehicle, also referred to as a charging socket, and can be arranged on a charging cable on the side of a charging station or on an electric vehicle. A charging plug arranged on a charging cable can be connected to a charging socket in order to thereby establish an electrical connection between a charging station and the electric vehicle and to electrically charge the electric vehicle.

In the field of electromobility, it is desirable to charge electric vehicles quickly and efficiently in order to reduce charging times and associated trip interruption times. In order to enable rapid charging of an electric vehicle within the context of a rapid charging process, high charging capacities are used, combined with large charging currents, for example with a current of 700 A or even higher. Current strengths up to 3000 A are conceivable for charging commercial vehicles.

In operation, heating can occur in plug contacts of a plug connector part via which a charging current is transmitted, and components which are connected to the plug contacts. For this, the standard stipulates that heating in components of a plug connector part must be limited and, for example, may exceed 50 K. Excessive heating in components of the plug connector part is therefore to be excluded.

In order to monitor the temperature during operation of the plug connector part in a charging system for charging an electric vehicle, in particular in the region of the plug contacts of the plug connector part, such plug contacts, which serve as load contacts for transmitting a charging current for charging an electric vehicle, are preferably associated with a temperature sensor assembly which is designed to detect the temperature in the associated plug contact and therefore to enable monitoring of a temperature change in the plug contact. Depending on the temperature monitoring, the operation of the plug connector part can be controlled in order, for example, in the event of an excessive temperature increase, to prevent a current flow and therefore a further temperature increase.

In a plug connector part of a charging system for charging an electric vehicle, considerable compressive and tensile forces can arise in the plug connector part and the plug contacts arranged on the plug connector part during a plugging process for the plugging connection of the plug connector part to the associated mating plug connector part. In this case, it must be ensured that a load on the plug contacts does not impair the fixed hold of the plug contacts on the plug connector part.

One design of a plug connector part in the form of a charging plug on a charging cable is known, for example, from DE 10 2018 108 181 A1 in which plug contacts are arranged on plug sections of the plug connector part.

EP 3 446 369 B1 describes a plug connector part in the form of a charging plug on a charging cable, in which sections of plug contacts are accommodated in a so-called cup housing.

### SUMMARY

In an embodiment, the present invention provides a plug connector part of a charging system for charging an electric vehicle, the plug connector part being connectable to a mating plug connector part along a plug-in direction, the plug connector part comprising: a housing part; a support element connected to the housing part; at least one electrical plug contact arranged on the support element and configured for plugging connection to a mating contact of the mating plug connector part; and a temperature sensor assembly arranged on the support element and having a temperature sensor element in operative connection with the at least one electrical plug contact, the temperature sensor element being configured to measure a temperature at the at least one electrical plug contact, wherein the temperature sensor element has a first engagement section in positive engagement with a second engagement section of the at least one electrical plug contact so that the at least one electrical plug contact is fixed axially along the plug-in direction relative to the support element.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a view of a charging station with a charging cable arranged thereon for connecting to an electric vehicle;

FIG. 2 shows a view of an exemplary embodiment of a plug connector part in the form of a charging socket;

FIG. 3 shows a view of a housing part of a plug connector part with a support element arranged thereon for supporting plug contacts realizing load contacts;

FIG. 4 shows a view of an assembly comprising the support element;

FIG. 5 shows a side view of the assembly;

FIG. 6 shows a front view of the circuit board;

FIG. 7 shows a top view of the assembly;

FIG. 8A shows a different front view of the assembly;

FIG. 8B shows a sectional view along line D-D shown in FIG. 8A;

FIG. 9A shows a side view of the assembly;

FIG. 9B shows a sectional view along line A-A shown in FIG. 9A;

FIG. 10 shows a separate view of the support element;

FIG. 11 shows another view of the support device;

FIG. 12 shows a rear view of the support element;

FIG. 13 shows another front view of the support element;

FIG. 14Ashows a side view of the arrangement according to FIG. 5;

FIG. 14B shows a sectional view along line D-D shown in FIG. 14A;

FIG. 15A shows the side view according to FIG. 9A;

FIG. 15B shows a sectional view along line B-B shown in FIG. 15A;

FIG. 16A shows the sectional view according to FIG. 8B; and

FIG. 16B shows a sectionally enlarged view of the sectionally view according to FIG. 16A.

### DETAILED DESCRIPTION

In an embodiment, the present invention provides a plug connector part which allows a reliable fixing of the at least one plug contact to the associated support element plug connector in a cost-effective manner.

Accordingly, the temperature sensor element has a first engagement section which is in positive engagement with a second engagement section of the at least one electrical plug contact so that the at least one electrical plug contact is fixed axially along the plug-in direction relative to the support element.

The support element of the plug connector part serves to support the at least one plug contact. The plug contact realizes, for example, a load contact for transmitting a charging current in the form of a direct current so that during operation, large currents can flow via the plug contact and correspondingly a high voltage can be applied to the plug contact.

The at least one electrical plug contact is connected to the support element. In contrast, the support element is connected to the housing part of the plug connector part so that the at least one plug contact is positioned on the housing part via the support element. The support element consists of an electrically insulating material and is fixedly connected, for example screwed, to the housing part.

An axial fixing of the at least one electrical plug contact relative to the support element takes place here via the temperature sensor element of the temperature sensor assembly which forms a first engagement section which is in engagement with a second engagement section of the at least one electrical plug contact. On the one hand, a temperature measurement on the at least one electrical plug contact is therefore made possible via the temperature sensor element of the temperature sensor assembly. On the other hand, in a synergistic double use, the temperature sensor element of the temperature sensor assembly also serves to mechanically fix the at least one electrical plug contact relative to the support element in that the temperature sensor element produces a positive engagement with the at least one electrical plug contact and therefore axially fixes the at least one electrical plug contact relative to the support element.

The temperature sensor element can be, for example, a temperature-sensitive electrical resistor (thermistor (NTC) or PTC thermistor (PTC), for example a so-called PT-100 or PT-1000 sensor), via which the temperature can be absorbed at the at least one electrical plug contact. In this case, the temperature sensor element is electrically separated from the at least one electrical plug contact, for example in that the temperature sensor element is encapsulated by an electrically insulating material and is therefore encased in an electrically insulating manner.

In one embodiment, the temperature sensor element is arranged in an opening of the support element. At a side of the support element pointing toward the at least one electrical plug contact, the first engagement section of the temperature sensor element is in positive engagement, for example, with the associated second engagement section of the at least one electrical plug contact. In contrast, for example, electrical lines can be connected to the temperature sensor element at a side of the temperature sensor element facing away from the at least one electrical plug contact.

In one embodiment, the temperature sensor assembly has a sealing element for the moisture-tight sealing of a transition between an edge section of the support element delimiting the opening and the temperature sensor element. The temperature sensor element therefore lies moisture-tight in the associated opening of the support element and is sealed relative to the support element by the sealing element so that no moisture can penetrate through the opening into the interior of the support element.

In one embodiment, the support element has at least one receiving chamber in which a section of the at least one electrical plug contact is accommodated. The receiving chamber can, for example, delimit a moisture-tight inner space in which the section of the at least one electrical plug contact is accommodated. The at least one plug contact is therefore enclosed moisture-tight in the support element so that moisture cannot (readily) pass into the region of the section of the at least one electrical plug contact.

The first engagement section of the temperature sensor element can be formed, for example, by a projection element of the temperature sensor element pointing radially inwards. In contrast, the second engagement section can, for example, be formed in the respective plug contact by a recess, for example in the form of a groove pointing radially inwards and formed into a shaft section of the plug contact. The plug contact rests with the shaft section, for example, in an associated receiving chamber of the support element. Due to the engagement of the engagement sections in each other, the plug contact is axially fixed relative to the support element, for example in the interior of an associated receiving chamber.

The positive engagement between the engagement sections is in particular such that the at least one electrical plug contact is fixed in an associated receiving chamber in a form-fit counter to an axial load along the plug-in direction. Due to the positive engagement of the temperature sensor element with the associated plug contact, the plug contact is fixed axially to the support element so that axially acting pressure and/or tensile forces occurring in particular during a plugging process can be absorbed and dissipated.

In one embodiment, the at least one electrical plug contact has a stop section which rests against a support section of the support element for axial support. The stop section can be formed, for example, by a shoulder of a cylindrical shaft section of the at least one electrical plug contact. In contrast, the support section of the support element can be shaped, for example, by a stepped contact surface, for example at one end of a cylindrical receiving chamber, on which the plug contact is axially supported. By means of the axial support, for example, tensile forces can be absorbed and dissipated at the at least one plug contact. In contrast, an axial fixation for absorbing and dissipating pressure forces at the at least one plug contact takes place for example primarily via the temperature sensor element.

In one embodiment, the plug connector part has at least two electrical plug contacts arranged on the support element for plugging connection to mating contact elements of the mating plug connector part. The at least two plug contacts realize in particular load contacts and are jointly supported by the support element and positioned on the housing part. The plug contacts are connected to the support element which in turn is fixed to the housing part of the mating plug connector part.

In one embodiment, the plug connector part can be connected to the mating plug connector part along a plug-in direction. In this case, the at least two plug contacts protrude from the support element along the plug-in direction.

For example, a plug-in section for a plugging connection to the mating plug connector part is arranged on the housing part, wherein the at least two plug contacts each have a contact section for electrically contacting with an associated mating contact element of the mating plug connector part, which is arranged in the region of the plug-in section. With the contact sections, the plug contacts protrude from the support element and project into the region of the plug-in section in such a way that the plug contacts can be electrically connected to the associated mating contacts of the mating connector part via the contact sections by plugging the plug-in section of the plug connector part into an assigned mating section of the mating connector part.

For example, the contact sections are located in associated openings accessible from the outside in the plug-in section so that electrical contacting of the contact sections with mating contacts can be established by a plugging connection of the plug-in section to the mating plug connector part.

The contact sections can, for example, be designed as contact sockets which can be brought into a plug-in electrical connection with mating contact elements in the form of contact pins. In another embodiment, the contact sections can be designed as contact pins which can be electrically connected to associated mating contact elements in the form of contact sockets.

In one embodiment, the support element has a first receiving chamber in which a section of a first of the at least two electrical plug contacts is accommodated, and a second receiving chamber in which a section of a second of the at least two electrical plug contacts is accommodated. The first receiving chamber delimits a first moisture-tight inner space in which the section of the first of the at least two electrical plug contacts is accommodated. The second receiving chamber delimits a second moisture-tight interior in which the section of the second of the at least two electrical plug contacts is accommodated.

The support element forms two receiving chambers which are each designed moisture-tight. A section of one of the associated plug contacts is located in each receiving chamber. Each receiving chamber is therefore associated with one of the plug contacts and encloses a section of the respective plug contact. The receiving chambers are separated from one another moisture-tight in that each receiving chamber delimits an inner space which is designed moisture-tight and therefore is sealed toward the outside in such a way that no moisture can penetrate into the interior.

The support element is fixedly connected to the housing part. A transition between the support element and the housing part can be sealed in this case moisture-tight so that no moisture can penetrate from the outside between the housing part and the support element into the housing interior of the plug connector part. The contact sections of the plug contacts projecting from the support element are electrically separated from one another by the seal between the support element and the housing part in that moisture cannot pass from the region of a contact section, for example in an associated plug-in opening in the plug-in section into the region of the other contact section in another spatially separated plug-in opening of the plug-in section.

Due to the fact that associated sections of the plug contacts are accommodated moisture-tight in the receiving chambers of the support element and are therefore enclosed from the outside, the sections of the plug contacts on the support element are functionally separate from one another and electrically insulated from one another in such a way that no voltage flashover or short-circuit can arise even in the event of any penetration of moisture into the interior of the housing of the plug connector part. The receiving chambers in the support element therefore provide drying chambers which are additionally sealed moisture-tight in the interior of the housing of the plug connector part in such a way that moisture is prevented from penetrating into the receiving chambers. However, even if moisture should penetrate into a receiving chamber, the electrical separation continues to exist, at least as long as the moisture tightness of the other receiving chamber is not impaired.

In one embodiment, the first inner space and the second inner space are hollow-cylindrical. A cylindrical shaft section of the first plug contact, for example, can be accommodated in the first inner space, while a cylindrical shaft section of the second plug contact, for example, is accommodated in the second inner space.

In one embodiment, each of the first receiving chambers and the second receiving chambers has a first opening through which the associated one of the at least two electrical plug contacts extends. The plug contacts preferably project from the support element with contact sections, for example in the form of contact sockets, and therefore project outward from the interior of the support element. Sections of the plug contacts are accommodated in the moisture-tight receiving chambers, wherein the plug contacts each extend outwardly through openings in the receiving chambers in order to enable a plugging connection of the plug contacts to associated mating contact elements of the mating plug connector part.

The first opening of each receiving chamber is preferably formed at a first axial end (with reference to the plug-in direction along which the plug connector part is to be connected to the mating plug connector part) of the receiving chamber which, for example, faces toward a plug-in section arranged on the housing part.

In one embodiment, a first sealing element is arranged in the first opening of each receiving chamber for the moisture-tight sealing of a transition between an edge section of the support element bordering the first opening and the associated one of the at least two electrical plug contacts. The associated plug contact extends outwardly through the first opening. A transition between the plug contact and the edge section bordering the opening is sealed via the first sealing element, so that moisture cannot penetrate through the first opening into the interior of the respective receiving chamber.

The first sealing element can, for example, be formed as a circumferential O-ring which extends around the respective plug contact and therefore creates a circumferential seal between the plug contact and the peripheral edge section of the opening.

In one embodiment, each of the first receiving chambers and the second receiving chambers has a second opening through which an electrical load line which is electrically connected to the associated one of the at least two electrical plug contacts extends. The load line is, for example, connected to the associated plug contact in the inner space enclosed by the receiving chamber and is electrically connected, for example crimped or welded, in particular ultrasonically welded, to the section of the plug contact enclosed in the inner space. The load line extends through a second opening of the corresponding receiving chamber to the outside so that the load line is guided out of the interior of the receiving chamber to the outside.

Due to the fact that the load line is inserted into the receiving chamber and is electrically connected to the associated plug contact in the interior of the receiving chamber, a connection region of the plug contact on which the connection is made is enclosed moisture-tight in the interior of the receiving chamber. The load line is preferably enclosed and electrically insulated on its extension path outside the receiving chamber in a cable sheath. In addition, the plug contacts are accommodated on the housing part outside the support element and are electrically separated from one another via the housing part. Where the load lines are connected to the plug contacts, the electrical separation takes place via the support element, in that such sections of the plug contacts, which form connection regions for connection to the load lines, are accommodated and enclosed within the receiving chambers of the support element.

The second opening of each receiving chamber is preferably formed at a second axial end of the associated receiving chamber. The second axial end is preferably distant from the first axial end and points away from the plug-in section arranged on the housing part, for example (with reference to the plug-in direction along which the plug connector part is to be connected to the mating plug connector part).

In one embodiment, a second sealing element is arranged in the second opening of each receiving chamber for the moisture-tight sealing of a transition between an edge section of the support element bordering the second opening and the load line. A transition between the load line and the support element which extends into the receiving chamber is therefore sealed moisture-tight via the second sealing element, so that no moisture can penetrate into the interior of the corresponding receiving chamber from the load line.

The second sealing element can be shaped, for example, like a disk with an opening formed therein for guiding the load line through.

In one embodiment, each of the first receiving chambers and the second receiving chambers has a third opening in which an associated temperature sensor assembly with a temperature sensor element of the type described above is arranged. While a first opening for guiding through the plug contact at a first axial end of the respective receiving chamber and a second opening can be shaped to guide a load line at a second axial end of the respective receiving chamber, the third opening is formed, for example, in the region of a lateral surface surrounding the receiving chamber, for example a cylindrical lateral surface, and is therefore arranged axially between the first opening and the second opening. A temperature sensor assembly, via which a temperature can be measured at each associated plug contact in the interior of the receiving chamber, is accommodated in the third opening.

In this case, each of the plug contacts is axially fixed via the associated temperature sensor element in the associated receiving chamber.

In one embodiment, the respective temperature sensor assembly has a third sealing element for the moisture-tight sealing of a transition between an edge section of the support element delimiting the third opening and the temperature sensor element. The temperature sensor element therefore lies moisture-tight in the associated, third opening of the respective receiving chamber and is sealed relative to the support element by the third sealing element, so that no moisture can penetrate through the third opening into the interior of the receiving chamber.

A charging system for charging an electric vehicle includes a plug connector part of the type described above. Such a charging system also includes a mating connector part that can be plugged into the plug connector part. The plug connector part can, for example, realize a charging plug which is arranged on a charging cable. In contrast, the mating plug connector part can be arranged, for example, as a charging socket on the electric vehicle and can be connected to the plug connector part in the form of the charging plug. The charging plug can, for example, be connected to a charging station via the charging cable so that charging currents can be transmitted from the charging station to the electric vehicle when the plug connector part and the mating plug connector part are in the connected position.

However, it is also conceivable for the plug connector part to realize a charging socket on the side of an electric vehicle.

A plug connector part of the type described here can in particular be used for transmitting charging currents in the form of direct currents. However, such a plug connector part can also serve to transmit charging currents in the form of alternating currents.

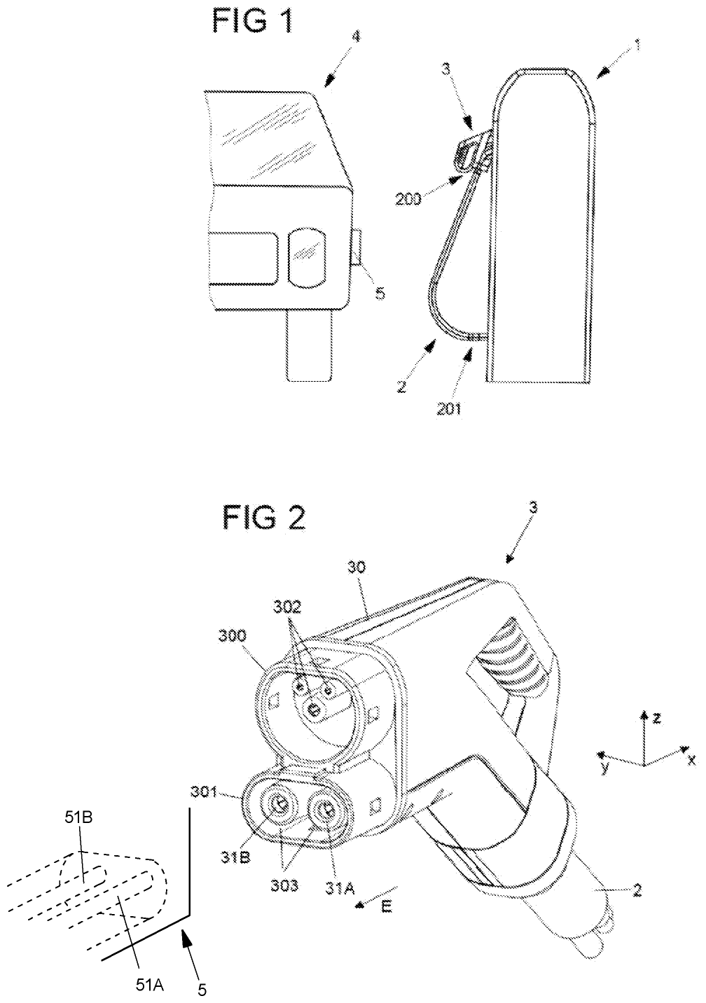

FIG. 1 shows a charging system comprising a charging station 1 which is used to charge an electrically powered vehicle 4, also referred to as an electric vehicle. The charging station 1 is designed to provide a charging current in the form of an alternating current or a direct current and has a cable 2 that is connected at one end 201 to the charging station 1 and at another end 200 to a mating plug connector part 3 in the form of a charging plug.

As can be seen from the views according to FIG. 2, the plug connector part 3 has plug-in sections 300, 301 on a housing 30, with which the plug connector part 3 can be brought into plugged-in engagement with an associated mating plug connector part 5 in the form of a charging socket on the vehicle 4. In this way, the charging station 1 can be electrically connected to the vehicle 4 in order to transmit charging currents from the charging station 1 to the vehicle 4.

In order to enable a rapid charging of the electric vehicle 4, for example within the framework of a so-called rapid charging process, the transmitted charging currents have a high current intensity, for example greater than 150 A, possibly even of the order of 500 A or even 700 A or more.

In the plug connector part 3 in the form of the charging plug according to FIG. 2, plug contacts are arranged on the upper plug-in section 300 on plug-in domes 302 and serve, for example, to transmit control signals or as grounding contact. In contrast, plug contacts 31A, 31B, which serve as load contacts for transmitting a charging current in the form of a direct current, are arranged on the lower plug-in section 301 on plug-in domes 303. When plugging in to the associated mating plug connector part 5 in the form of the charging socket on the electric vehicle 4, the plug contacts 31A, 31B come into electrical contact with associated mating contact elements 51A, 51B on the charging socket 5 so that a charging current can be transmitted from the charging station 1 to the electric vehicle 4.

Since high voltages can be applied to the plug contacts 31A, 31B that are load contacts during operation, care must be taken to ensure that a voltage flashover or short circuit cannot occur between the plug contacts 31A, 31B and current-carrying components electrically connected to the plug contacts 31A, 31B. To this end, it is particularly important to prevent moisture inside the housing 30 (perhaps not be sealed from the outside) from impairing the electrical separation of the plug contacts 31A, 31B and the current-carrying components assigned to the plug contacts 31A, 31B from one another inside the housing 30.

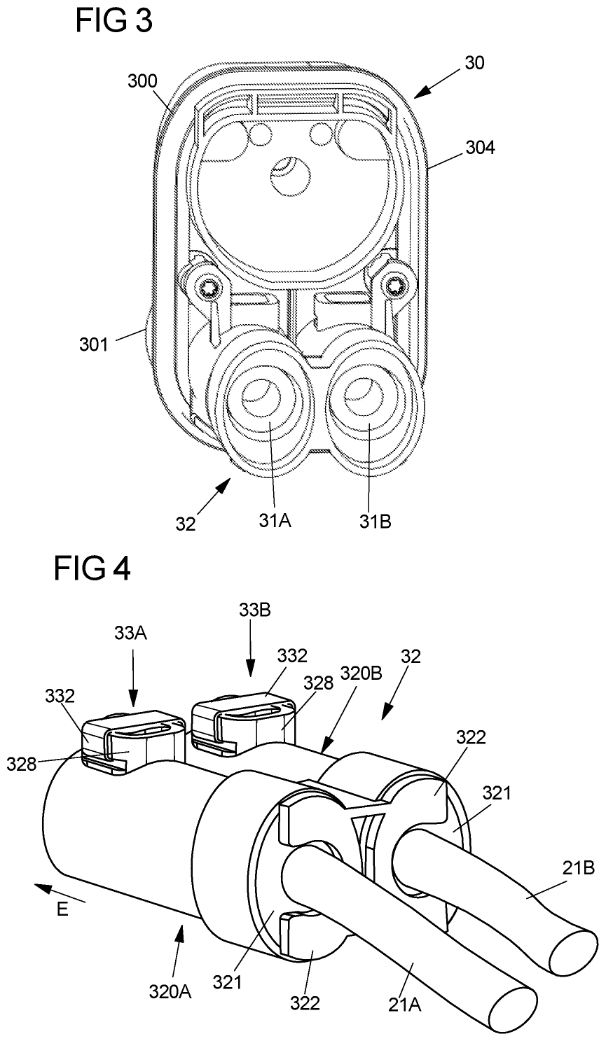

In the shown embodiment, the plug contacts 31A, 31B are arranged on a support element 32 which is fixedly connected to a housing part 304 of the housing 30 of the plug connector part 3, as can be seen from FIG. 3. The plug contacts 31A, 31B are positioned and fixed on the housing part 304, and therefore on the lower plug section 301 which is formed on the housing part 304, by the support element 32.

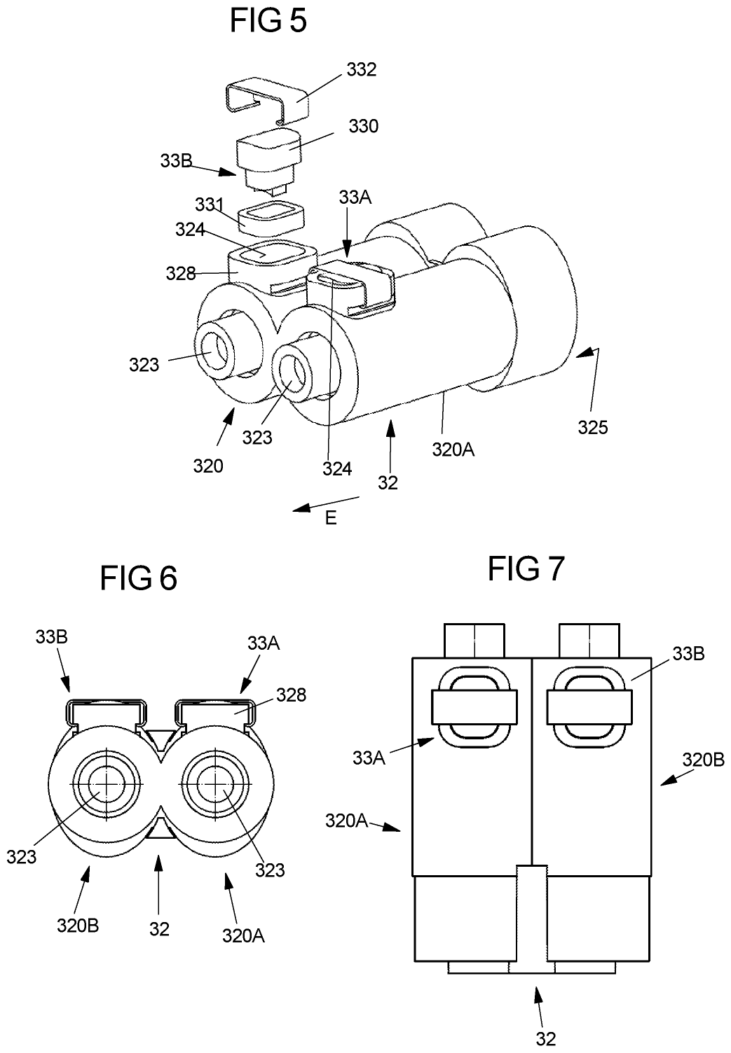

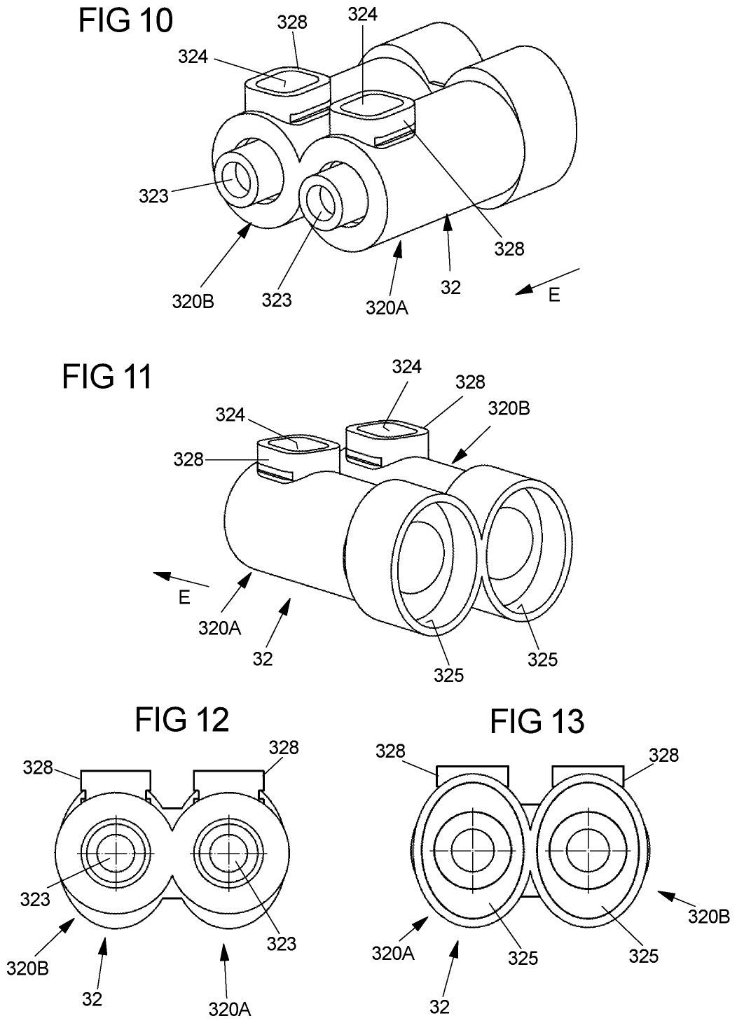

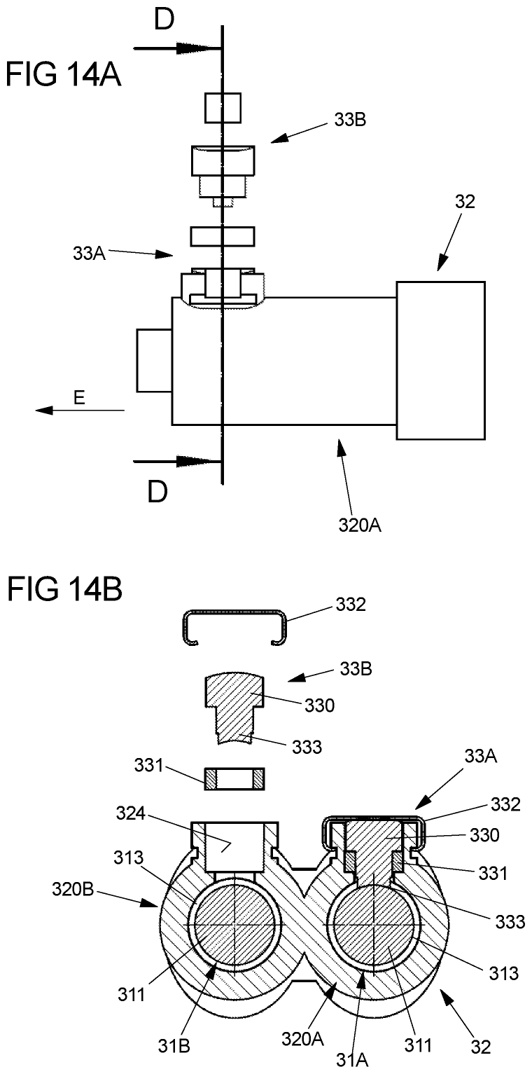

As can be seen from FIGS. 4 to 16A, 16B which show the support element 32 with and without the plug contacts 31A, 31B in different views, the support element 32 forms two receiving chambers 320A, 320B which each surround an inner space 327A, 327B. The receiving chambers 320A, 320B each have a cylindrical basic shape and, viewed along a transverse direction extending transversely to the plug-in direction E, are formed next to one another on the support element 32.

Corresponding to the shaping of the receiving chambers 320A, 320B, the inner spaces 327A, 327B enclosed by the receiving chambers 320A, 320B are hollow-cylindrical.

A plug contact 31A, 31B is accommodated in each receiving chamber 320A, 320B. The respective plug contact 31A, 31B here rests with a cylindrical shaft section 311 in each associated receiving chamber 320A, 320B and is accommodated moisture-tight with the shaft section 311 in the inner space 327A, 327B.

Each plug contact 31A, 31B extends outwardly through a first opening 323 of the associated receiving chamber 320A, 320B and protrudes, with a contact section 310, for example in the form of a contact socket, from the support element 32 in the direction of the plug section 301 of the housing part 304 in such a way that the contact sections 310 lie in the plug-in domes 303 in the area of the plug-in section 301 and are therefore accessible from the outside for plugging connection with the assigned mating contacts 51A, 51B of the mating connector part 5.

A sealing element 326 in the form of an O-ring running around around the plug-in direction E is arranged in each opening 323 and seals a transition moisture-tight between the respective plug contact 31A, 31B and an edge section of the support element 32 bordering the opening 323 so that no moisture can reach the interior of the respective receiving chamber 320A, 320B from the outside through the opening 323.

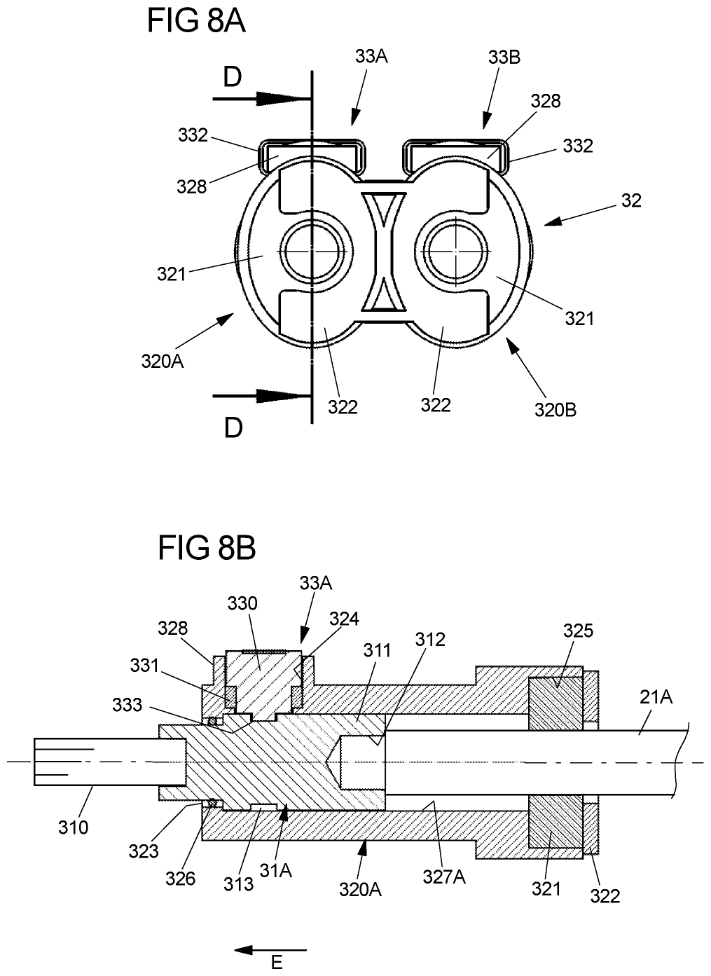

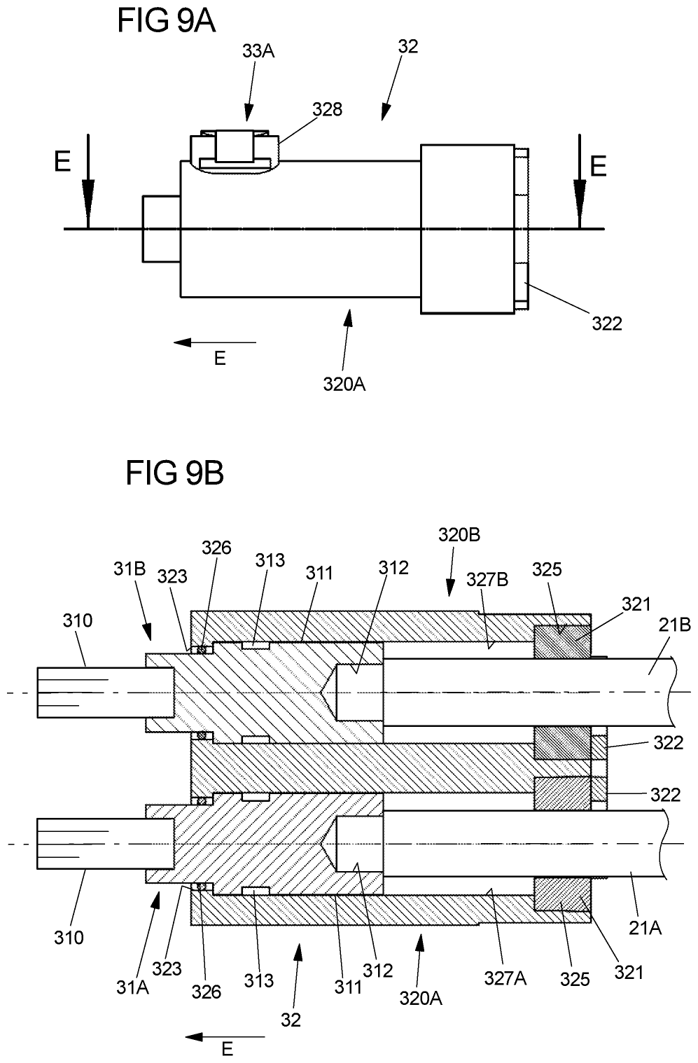

The shaft sections 311 of the plug contacts 31A, 31B, which are accommodated in the interior of the receiving chambers 320A, 320B, form connection sections 312 to which load lines 21A, 21B are connected, as can be seen in particular from the sectional views according to FIG. 8B and 9B. Each plug contact 31A, 31B is therefore connected to an associated load line 21A, 21B in the associated receiving chamber 320A, 320B. The respective load line 21A, 21B extends through a sealing element 321 in a second opening 325 of the associated receiving chamber 320A, 320B and out of the respective receiving chamber 320A, 320B so that the load line 21A, 21B is guided outward from the respective receiving chamber 320A, 320B.

A transition between the load line 21A, 21B and an edge section of the support element 32 bordering the opening 325 is sealed moisture-tight via the sealing element 321 which is shaped like a disk with an opening formed therein for passing through the respective load line 21A, 21B so that no moisture can penetrate into the interior of the respective receiving chamber 320A, 320B through the opening 325.

The second opening 325 of a respective receiving chamber 320A, 320B is formed in an axial end of the receiving chamber 320A, 320B which is remote from the housing part 304. In contrast, the first opening 323 is formed in an axial end of the respective receiving chamber 320A, 320B which faces the housing part 304.

The sealing elements 321 are inserted into the openings 325 of the receiving chambers 320A, 320B and secured in position on the support element 32 by means of fastening elements 322.

A housing section 328 projecting radially outwards is formed on each receiving chamber 320A, 320B, within which housing section 328 an opening 324 is formed, in which a temperature sensor assembly 33A, 33B is accommodated. Each temperature sensor assembly 33A, 33B has a temperature sensor element 330 and a sealing element 331 which are connected together via a fixing element 332 in the form of a bow-shaped fastening clip to the housing section 328 and therefore to the support element 32.

A temperature sensor assembly 33A, 33B is associated with each plug contact 31A, 31B in each receiving chamber 320A, 320B, via which temperature sensor assembly 33A, 33B the temperature at the corresponding plug contact 31A, 31B can be measured and therefore monitored during operation. The temperature sensor element 330 inserted in the opening 324 bordered by the housing section 328 is in mechanical contact with each associated plug contact 31A, 31B so that the temperature can be taken at each associated plug contact 31A, 31B via the temperature sensor element 330, for example in the form of a temperature-sensitive electrical resistance (thermistor (NTC) or PTC thermistor (PTC)).

A transition between the temperature sensor element 330 and the housing section 328 is sealed moisture-tight via the sealing element 331 so that no moisture can penetrate from the outside through the opening 324 into the interior 327A, 327B of the respective receiving chamber 320A, 320B.

Each temperature sensor element 330 forms an engagement section 333 in the form of a projection projecting radially inwards, which projection engages in a form-fit with an associated engagement section 313 in the form of a circumferential groove formed radially inwards into the cylindrical shaft section 311 of the associated plug contact 31A, 31B. Due to the form-fit, the respective plug contact 31A, 31B is fixed axially in the receiving chamber 320A, 320B and hence relative to the support element 32 so that the respective plug contact 31A, 31B is mechanically fixed relative to the support element 32.

The form-fit is in particular such that pressure and/or tensile forces acting axially along the plug-in direction E during a plugging process can be absorbed and dissipated. The mechanical fixing of the plug contacts 31A, 31B on the support element 32 is therefore established by the form-fit produced by the temperature sensor assembly 33A, 33B.

For example, the temperature sensor element 330 is electrically insulated from the associated plug contact 31A, 31B in such a way that the temperature sensor element 330 is encapsulated by an electrically insulating material and is therefore encased in an electrically insulating manner. The temperature sensor element 330 in this case lies directly against the plug contact 31A, 31B and can therefore efficiently detect a temperature at each associated plug contact 31A, 31B.

Data lines for transmitting a sensor signal, for example for connecting the temperature sensor element 330 to a control unit, can, for example, be connected to the temperature sensor element 330 outside the opening 324.

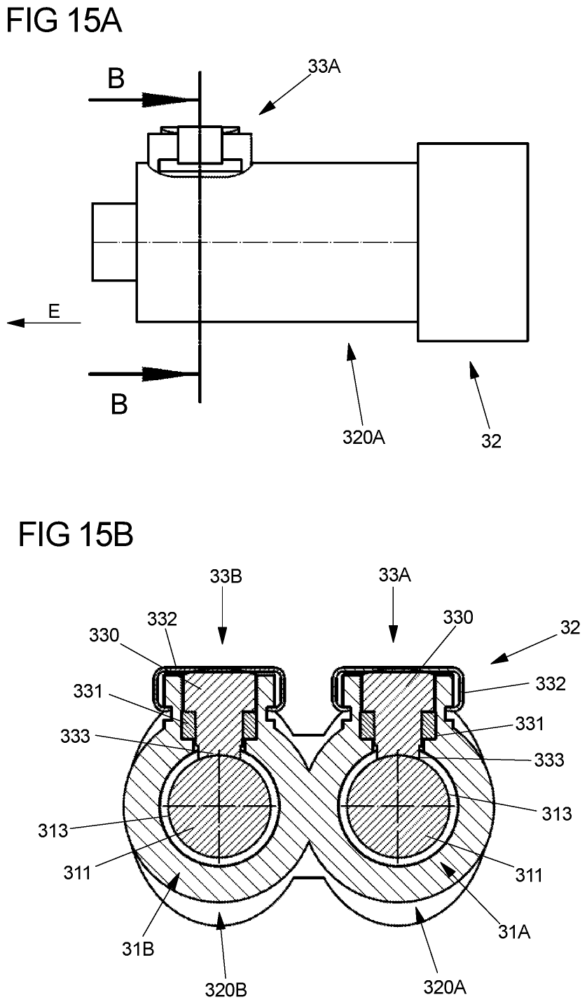

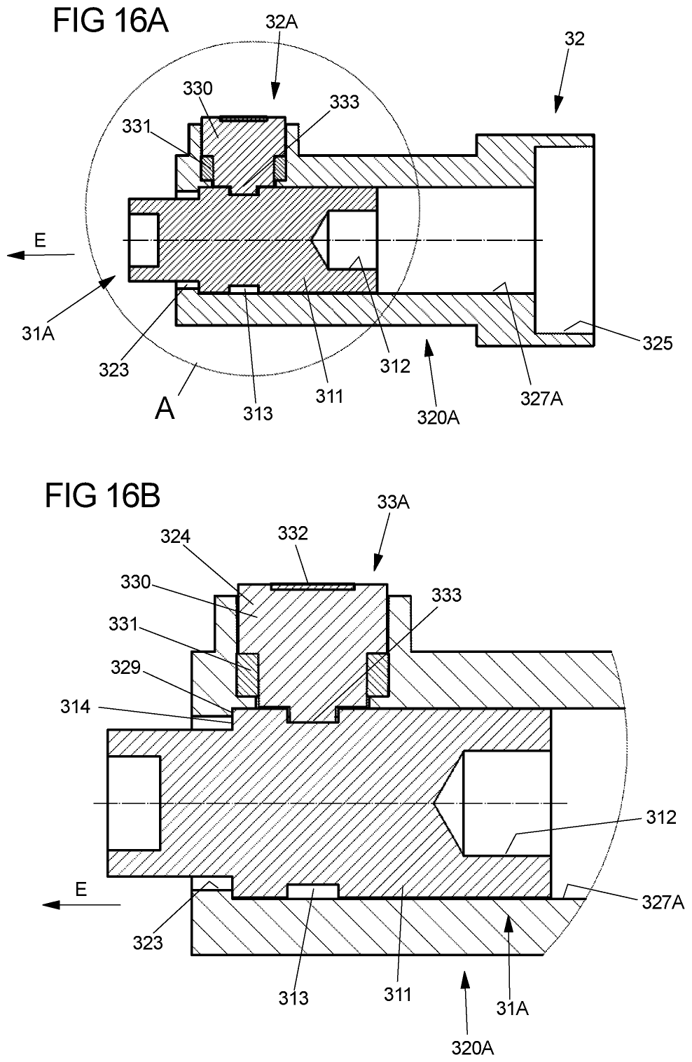

As can be seen from the enlarged sectional view according to FIG. 16B and also from the sectional view according to FIG. 15B, the engagement sections 333 of the temperature sensor elements 330 of the temperature sensor assembly 33A, 33B formed by projections are in associated, groove-shaped, circumferential recesses in the shaft section 311 of each associated plug contact 31A, 31B and thereby produce an axial, mechanical securing on the plug contact 31A, 31B. In particular, due to the positive engagement, each plug contact 31A, 31B is fixed axially relative to the support element 32 such that pressure and/or tensile forces can be absorbed and dissipated and cannot lead to a change in position of the plug contacts 31A, 31B relative to the support element 32.

As can be seen from the enlarged sectional view according to FIG. 16B, the shaft section 311 of each plug contact 31A, 31B lies with a contact section 314 formed by a shoulder against an associated support section 329 at the axial end of the respective receiving chamber 320A, 320B at which the opening 323 is formed. Via the supporting contact of the contact section 314 on the support section 329, the respective plug contact 31A, 31B is supported relative to the support element 32 in such a way that tensile forces acting on the plug contact 31A, 31B, for example in a pulling process for separating the plug connection, can be absorbed and diverted both via the engagement of the temperature sensor element 330 with the shaft section 311 and by the supporting contact of the contact section 314 with the support section 329, and therefore tensile loads as well cannot lead to a change in position of the plug contacts 31A, 31B.

The receiving chambers 320A, 320B create mutually separated inner spaces 320A, 320B in which the shaft sections 311 of the plug contacts 31A, 31B are accommodated separately from one another. Due to the moisture-tight design of the receiving spaces 320A, 320B, moisture cannot penetrate into the interior of the receiving chambers 320A, 320B so that in particular the connection regions 312 of the plug contacts 31A, 31B to which the load lines 21A, 21B are connected are accommodated moisture-tight in the interior of the receiving spaces 320A, 320B.

The support element 32 is preferably sealed moisture-tight from to the housing part 304 in such a way that the contact sections 310 of the plug contacts 31A, 31B projecting into the plug-in domes 303 are spatially separated from one another and separated from one another moisture-tight on the housing part 304.

The idea forming the basis of the invention is not limited to the exemplary embodiments described in the preceding, but can also be realized in another way.

A plug connector part of the type at issue here can realize a charging plug, for example on a charging cable or a charging socket, for example on an electric vehicle.

Such a plug connector part can in particular serve to transmit a charging current in the form of a direct current. However, it is also conceivable for the plug connector part is designed to transmit a charging current in the form of an alternating current.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Charging station
2 Charging cable
200, 201 End
21A, 21B Load line
3 Charging plug
30 Housing
300, 301 Plug section
302, 303 Plug-in dome
304 Housing part
31A, 31B Plug contact
310 Contact section
311 Shaft section
312 Connection section
313 Engaging section
314 Stop section
32 Support element
320A, 320B Receiving chamber
321 Sealing element
322 Fastening element
323 Opening
324 Opening
325 Opening
326 Sealing element
327A, 327B Interior
328 Housing section
329 Support section
33A, 33B Temperature sensor assembly
330 Temperature sensor element
331 Sealing element
332 Fixing element
333 Engaging section
4 Vehicle
5 Charging socket
51A, 51B Mating contacts
E Insertion direction
X Longitudinal direction
Y Transverse direction
Z Height direction

1. A plug connector part of a charging system for charging an electric vehicle, the plug connector part being connectable to a mating plug connector part along a plug-in direction, the plug connector part comprising:
a housing part;
a support element connected to the housing part;
at least one electrical plug contact arranged on the support element and configured for plugging connection to a mating contact of the mating plug connector part; and
a temperature sensor assembly arranged on the support element and having a temperature sensor element in operative connection with the at least one electrical plug contact, the temperature sensor element being configured to measure a temperature at the at least one electrical plug contact,
wherein the temperature sensor element has a first engagement section in positive engagement with a second engagement section of the at least one electrical plug contact so that the at least one electrical plug contact is fixed axially along the plug-in direction relative to the support element.

2. The plug connector part of claim 1, wherein the temperature sensor element is arranged in an opening of the support element.

3. The plug connector part of claim 2, wherein the temperature sensor assembly has a sealing element configured for moisture-tight sealing a transition between an edge section of the support element bordering the opening and the temperature sensor element.

4. The plug connector part of claim 1, wherein the support element has at least one receiving chamber in which a section of the at least one electrical plug contact is accommodated.

5. The plug connector part of claim 4, wherein the at least one receiving chamber delimits a moisture-tight interior in which the section of the at least one electrical plug contact is accommodated.

6. The plug connector part of claim 1, wherein the first engagement section is formed by a projection of the temperature sensor element, and the second engagement section is formed by a recess in the at least one electrical plug contact.

7. The plug connector part of claim 1, wherein the at least one electrical plug contact has a stop section which rests against a support section of the support element for axial support.

8. The plug connector part of claim 1, wherein the at least one electrical plug contact comprises at least two electrical plug contacts arranged on the support element and configured for plugging connection to mating contacts of the mating plug connector part.

9. The plug connector part of claim 8, wherein the at least two plug contacts project from the support element along the plug-in direction.

10. The plug connector part of claim 8, wherein a plug-in section for a plugging connection to the mating plug connector part is arranged on the housing part, and
wherein the at least two plug contacts each have a contact section configured to electrically contact an associated mating contact of the mating plug connector part which is arranged in a region of the plug-in section.

11. The plug connector part of claim 8, wherein the support element has a first receiving chamber in which a section of a first electrical plug contact of the at least two electrical plug contacts is accommodated, and a second receiving chamber in which a section of a second electrical plug contact of the at least two electrical plug contacts is accommodated, and
wherein the first receiving chamber delimits a first moisture-tight inner space in which the section of the first electrical plug contact is received, and the second receiving chamber delimits a second moisture-tight inner space in which the section of the second electrical plug contact is accommodated.

12. The plug connector part of claim 11, wherein the first inner space and the second inner space are hollow-cylindrical.

13. The plug connector part of claim 11, wherein each of the first receiving chambers and the second receiving chambers has a first opening through which each associated one electrical plug contact of the at least two electrical plug contacts extends.

14. The plug connector part of claim 13, wherein the first opening is formed in a first axial end of the associated receiving chamber.

15. The plug connector part of claim 13, wherein a first sealing element is arranged in the first opening for moisture-tight sealing of a transition between an edge section of the support element bordering the first opening and each associated one electrical plug contact of the at least two electrical plug contacts.

16. The plug connector part of claim 15, wherein each of the first receiving chambers and the second receiving chambers has a second opening through which an electrical load line which is electrically connected to each associated one electrical plug contact of the at least two electrical plug contacts extends.

17. The plug connector part of claim 16, wherein the second opening is formed in a second axial end of the associated receiving chamber.

18. The plug connector part of claim 16, wherein a second sealing element is arranged in the second opening for moisture-tight sealing of a transition between an edge section of the support element delimiting the second opening and the load line.

19. The plug connector part of claim 16, wherein each of the first receiving chambers and the second receiving chambers has a third opening in which an associated temperature sensor assembly is arranged.

20. A charging system for charging an electric vehicle, comprising:
the plug connector part of claim 1.
